(19) United States
(12) Patent Application Publication
(10) Pub. No.: US 2021/0125791 A1
(43) Pub. Date: Apr. 29, 2021

(54) INCORPORATION OF LITHIUM-ION SOURCE MATERIAL INTO AN ACTIVATED CARBON ELECTRODE FOR A CAPACITOR-ASSISTED BATTERY

(71) Applicant: GM GLOBAL TECHNOLOGY OPERATIONS LLC, Detroit, MI (US)

(72) Inventors: Zhe LI, Shanghai (CN); Xiaochao QUE, Shanghai (CN); Jingjing WU, Shanghai (CN); Xiusheng ZHANG, Shanghai (CN)

(73) Assignee: GM GLOBAL TECHNOLOGY OPERATIONS LLC, Detroit, MI (US)

(21) Appl. No.: 17/047,198

(22) PCT Filed: Apr. 20, 2018
(86) PCT No.: PCT/CN2018/083916

§ 371 Date: Oct. 13, 2020

(51) Int. Cl. H01G 11/08; H01M 12/00; H01M 4/525; H01M 4/583; H01M 4/505; H01M 10/0525; H01G 11/06; H01G 11/26; H01G 11/38; H01G 11/50; H01G 11/34

(52) U.S. Cl. CPC H01G 11/08; H01M 12/00; H01M 4/525; H01M 4/583; H01M 4/505; H01M 2004/027; H01G 11/06; H01G 11/26; H01G 11/38; H01G 11/50; H01G 11/34; H01M 10/0525

(57) ABSTRACT

A hybrid lithium-ion battery/capacitor cell (10) comprising at least a pair of graphite anodes (14,18) assembled with a lithium compound cathode (12) and an activated carbon capacitor electrode (16) can provide useful power performance properties and low temperature properties required for many power-utilizing applications. The initial formation of the graphite anodes (14,18) of this hybrid cell (10) combination is enhanced by including particles of a selected lithium compound with the activated carbon particles used in forming the capacitor electrode(16). The composition of the lithium compound is selected to produce lithium ions in the liquid electrolyte of the assembled cell (10) to enhance the in-situ lithiation of the graphite particles of the anodes (14,18) during formation cycles of the assembled hybrid cell (10).

### TECHNICAL FIELD

This disclosure pertains to the formation of an activated carbon capacitor for hybrid lithium battery/capacitor cells that is to be located between two graphite anodes in a hybrid cell group. Particles of a selected lithium compound are mixed with particles of activated carbon in the preparation of the capacitor electrode and the electrodes assembled and infiltrated with a non-aqueous liquid electrolyte. The lithium content of the capacitor electrode is used in in-situ lithiation of the graphite anodes during formation cycles of the hybrid cell.

### BACKGROUND OF THE INVENTION

Background statements in this section are not necessarily prior art.

There is increasing interest in the development of hybrid electrochemical cells which contain lithium-ion battery electrodes used in combination with a capacitor electrode in which the capacitor material is activated carbon particles. For example, such a hybrid cell might be formed with a pair of electrically-connected, negatively-charged (during cell-discharge) graphite-particle anode members and a cathode member electrically-connected with a positively-charged capacitor using activated carbon as its active capacitor material.

It is contemplated that such a hybrid cell and others, with other groupings of assembled battery electrodes and capacitor electrode(s), could be prepared with electrode compositions and amounts that could provide a range of battery/capacitor properties including different, useful combinations of energy densities (Wh/kg) and power densities (W/kg) in a hybrid electrochemical cell that adapt the hybrid cell's use in different applications.

In such hybrid cells, for example, in which two graphite anode electrodes, a suitable lithium-metal phosphate cathode (e.g., lithium iron phosphate, LiFePO₄), and an activated carbon capacitor(s) are physically spaced by porous separators and infiltrated with a non-aqueous solution of a lithium compound (e.g., LiPF₆), it is necessary to initially incorporate lithium ions into the graphite material of the two anodes that face toward the activated carbon capacitor electrode.

Preferably, such incorporation of lithium ions, inserted into the graphite anodes, can be accomplished in-situ, after infiltration of assembled cell members with the liquid electrolyte, rather than as an “add-on” step, before the cell is assembled. The following disclosure is directed to such a process.

### SUMMARY OF THE INVENTION

As an illustrative, non-limiting example, a hybrid lithium-ion battery/capacitor cell may contain as few as four electrodes. In this example, two electrically-connected, negatively-charged (during cell discharge) graphite anodes are assembled with a cathode of suitable lithium-containing composition (e.g., lithium iron phosphate, LiFePO4) which is electrically connected to an activated carbon capacitor cathode. The graphite anodes are typically placed on opposing sides of the activated carbon capacitor cathode. Activated carbon particles are commercially available, and such carbon particles are prepared with high levels of porosity which enable them to adsorb and desorb suitable ions during their capacitor function in the hybrid electrochemical cell. This basic four-member hybrid cell may be combined with other groups of battery electrodes or with like hybrid cells.

Each of the respective electrodes is typically formed of particles of the selected electrode material, mixed with a small proportion of electrically-conductive carbon particles, and resin-bonded as a thin porous layer (e.g., up to about 150 μm in thickness) to one or both sides of a compatible current collector foil (e.g., an aluminum or copper foil, about 4 μm to 25 μm in thickness). The shapes of the electrodes in an assembled cell are often round or rectangular so that they can be stacked with interposed porous separators in the assembly of each electrochemical cell. Sometimes the electrodes are formed as relatively long rectangular strips which are assembled in layers with interposed separator strips and wound into circular or rounded-edge discs in the assembly of the cell. The closely-spaced, assembled electrodes are placed in a suitable container and infiltrated with a non-aqueous liquid solution of a suitable lithium electrolyte compound, such as lithium hexafluorophosphate, LiPF₆, dissolved in a mixture of liquid alkylene carbonates. The anode electrodes are electrically connected (typically using uncoated tabs on their current collectors) and the cathode and capacitor electrodes are likewise, separately connected. The tabs or other connectors will be connected to other electrodes or cells and/or an external circuit in the charging and discharging of the hybrid cell.

At this point in the initial assembly of the hybrid cell, it is necessary to apply a series of electrical potentials to the electrodes, in a series of cell formation cycles, for the purpose of transporting lithium ions from the electrolyte into the graphite particles of the anode electrodes (lithiation). During the formation process, graphite particles in the anodes react with lithium ions from the electrolyte to form the graphite intercalation compound (GIC), LiC₆, in the anode material. In a conventional lithium-ion battery cell, the cathode materials typically provide sufficient lithium content for lithiation of the graphite anode particles. But it is recognized herein that the replacement of a lithium-containing cathode with an activated carbon capacitor cathode can affect the supply (availability) of lithium ions to the adjacent graphite anodes due to the capacity mismatch between graphite and activated carbon. During lithium-ion capacitor charging, the activated carbon cathode could only enable a limited amount of lithium ions to transfer to the graphite anode. However, a solid electrolyte interface (SEI) needs to be formed initially on the graphite anode, which will irreversibly consume most of the lithium ions transferred during the initial cycles.

In accordance with practices of this invention, the supply of lithium ions is increased and enhanced by a new method for the formation of the activated carbon-based capacitor electrode. The capacitor electrode is formed by uniformly mixing a major portion of activated carbon particles with a suitable addition of particles of a suitable lithium compound(s). Preferably the particles of the lithium compound are sized (e.g., 50 nm to 30 μm) and shaped for mixing with the activated carbon capacitor particles. Particles of the lithium compound are resin-bonded to, and with, the activated carbon (AC) particles in the porous capacitor cathode material layers bonded to the opposing surfaces of an aluminum or copper current collector foil. The particles of the lithium compound are then contacted and wetted by the liquid electrolyte. Upon the application of a cell-charging potential during cell formation cycles, lithium ions enter the electrolyte from both the cathode particles and the mixed capacitor particles for transport in and through the electrolyte and reaction with graphite particles in an adjacent anode. Thus, the lithium-ion source material (LiSM) particles, mixed with AC particles in the capacitor electrode, better enables the in-situ lithiation of the graphite particles in a near-by anode during cell formation. Such lithiation comprises forming a solid electrolyte interface (SEI) necessary for suitable function of such anode particles, and then the formation of the graphite intercalation compound (GIC) on the graphite particles. The lithium content of the solid electrolyte interface is typically retained in the graphite content of the anodes.

In accordance with practices of this invention, it is found that different lithium compounds function in different ways as a lithium-ion source material during and after providing lithium ions for in-situ anode lithiation during cell formation. The function of the selected lithium compound depends upon its chemical and electrochemical activity in the cell environment of the electrolyte and the activated carbon capacitor particles. These differences are discussed in detail in a following section of this specification.

Other objects and advantages of the invention will be apparent from the drawing figures and the detailed description provided in the following text of the specification.

### BRIEF DESCRIPTION OF THE DRAWINGS

FIG. 1 is a schematic cross-sectional view of the side edges of a basic four-electrode hybrid lithium-ion battery/activated carbon capacitor cell. In the schematic figure, a pair of vertically-oriented, rectangular-shaped, electrically-connected, negatively-charged graphite anodes are assembled with like-sized, shaped and vertically-positioned combination of a lithium iron phosphate (LFP) cathode and an activated carbon capacitor cathode containing particles of an LiSM. The LFP cathode and capacitor cathode are electrically connected and positively charged. In the hybrid cell assembly of FIG. 1, the capacitor cathode is positioned between facing electrode-material coated surfaces of the graphite anodes and the LFP cathode is positioned on the opposite side of one of the anodes. A like-sized and shaped thin porous polymeric separator is placed between adjacent electrodes in the assembly to physically separate them. The four electrodes and three separators are spaced apart in the illustration of FIG. 1 for purposes of simpler illustration of the respective electrodes.

In a fully assembled cell, the four electrodes and their separators would be in stacked, touching contact, and the assembly would be placed in a container and infiltrated with a liquid electrolyte. Only the electrodes and separators are illustrated in FIG. 1 to more easily illustrate their cross-sectional structures.

FIG. 2 is a graph of Voltage (V) vs. Capacity (mAh), displaying the data obtained during the formation cycle (at 0.2 C) and the first and second charge-discharge cycles (at 1 C) for a cell formed of a negatively-charged, graphite, lithium battery anode and a positively-charged activated carbon capacitor electrode. The charge and discharge curves for the formation cycle are indicated by small open triangles. The charge and discharge curves for the 1^{st} cycle and 2^{nd} cycle are respectively indicated by small open squares and small open circles. The cell was a pure lithium-ion capacitor unit (sometimes, LIC) operated with an electrolyte of 1.2 M LiPF₆ dissolved in a 1:1:2 proportion mixture of ethylene carbonate, dimethyl carbonate and ethyl methyl carbonate. The LIC cell was operated at 25° C. and cycled between 2.5 V and about 3.6 V.

### DESCRIPTION OF PREFERRED EMBODIMENTS

An important feature of this disclosure and invention is the incorporation of particles of a suitable Li-ion source material (LiSM) with particles of activated carbon (often AC in this specification) in the formation of the porous layers of capacitor material suitably bonded to a metal foil current collector. The incorporated particles of a selected lithium compound are used to provide lithium cations for introduction into the liquid electrolyte infiltrating the porous composite capacitor material. The particles of lithium compound(s) provide lithium ions that supplement the supply of lithium ions from the particles of cathode material and from the electrolyte for interaction with the graphite anodes.

Under the electrical potential applied to the electrodes of the cell during the formation cycles of the newly assembled cell, lithium ions are transported from the particulate LiSM capacitor material and the particulate cathode material into the lithium-ion conducting electrolyte and into pores of the adjacent (except for the porous separators), facing layers of the porous graphite particles of the anode material. Generally speaking, lithium cations in the liquid electrolyte of the cell are solvated with solvent molecules from the electrolyte. The solvated lithium ions intercalate into the graphite particles of the anode at the beginning of the initial charging process. Decomposition of co-intercalated lithium ions and solvent molecules occurs and a solid electrolyte interface (SEI) is formed on the anode particles. Thus, some irreversible consumption of lithium and electrolyte occurs.

The formed SEI appears to act as a passivation layer that enables lithium ion intercalation during charging of the cell and lithium ion deintercalation (and release electrons to the anode current collector) when the cell is being discharged. Thus, the presence of LiSM particles mixed with AC particles in the capacitor electrode, complements and supplements the lithium present in the connected lithium-ion battery cathode and the electrolyte. And the presence of the LiSM in the AC capacitor electrode simplifies the preparation and assembly process otherwise requiring pre-lithiated graphite anodes in hybrid cells using AC capacitors.

Obviously, the lithium compound particles, mixed and dispersed in the AC capacitor cathode, must be compatible with the selected electrolyte used in the hybrid cell and have suitable electrochemical capacities in the presence of the electrolyte and the activated carbon particles. The lithium compounds identified below in this specification are compatible with commonly-used lithium electrolytes such as LiPF₆ and the alkylene carbonate solvents in which it is dissolved.

Suitable LiSM materials should have a lower Li+ extraction potential (plateau) than the upper potential limit of the AC particles in the electrochemical environment of the capacitor electrode. This enables sufficient de-lithiation of the selected LiSM during the formation cycling of the cell within the working potential range of the activated carbon particles.

But it is found that three different situations may occur during discharge of the cell when it might be expected that some lithium ions could be returned to the selected particles of LiSM material in the mixture of capacitor materials (AC and LiSM)

In the following listing of LiSM materials, it will be observed that three types of LiSM materials may be considered.

A first Type A of lithium-ion source materials provide lithium ions for the lithiation of graphite anode particles, but the lithium ion release of these compounds is irreversible in the environment of the hybrid cell. Such Type A compounds include:

The organic lithium salt, 3,4-dihydroxybenzonitrile dilithium.

Lithium salts including azides (LiN₃), oxocarbons, dicarboxylates, and hydrazides.

Lithium nitride (Li₃N), lithium nickel oxide (e.g., Li_{0.65}Ni_{1.35}O₂, Li₅FeO₄, Li₅ReO₆, Li₆CoO₄, Li₃V₂(PO₄)₃, and other lithium transition metal oxides.

Particles of these lithium compounds may be used with activated carbon capacitor particles in the initial lithiation of the graphite anode particles, but these LiSM compounds will not combine with lithium ions during subsequent cycling of the hybrid cell. In this embodiment, lithium ions in the LiSM can be permanently transferred into the graphite anode particles.

And no further reaction of this LiSM takes place in the activated carbon particles of the capacitor. In general, it is preferred that the particles of a Type A LiSM make up about two to thirty percent by weight of the LiSM+AC content of the active materials of the capacitor electrode.

The following LiSM compounds, Type B, exhibit lower Li+ insertion potentials (plateaus) than the lower working potential limit of activated carbon (AC Vmin). These de-lithiated compounds become electrochemically inactive in the AC once they have released their lithium ions. The Type B lithium compounds include:

Lithium fluoride (LiF) and LiF/transition metal composites such as Li₂O/Co, Li₂O/Fe, and Li₂O/Ni.

Li₂S, and Li₂S metal composites such as Li₂S/Co. Lithium Cuprate (Li₂CuO₂) Li₂NiO₂, Al₂O₃-coated Li₂NiO₂ and other oxides coated with Li₂NiO₂.

Li₂MoO₃

Other lithium transition-metal oxides.

Particles of these lithium compounds may be used with activated carbon capacitor particles in the initial pre-lithiation of the graphite anode particles, but these LiSM compounds will not combine with lithium ions during subsequent cycling of the hybrid cell. No further reaction of this LiSM takes place in the activated carbon particles of the capacitor. In general, it is preferred that the particles of a Type B LiSM make up about two to thirty percent by weight of the LiSM+AC content of the active materials of the capacitor electrode.

The following LiSM compounds, Type C, exhibit Li+ insertion potentials within the working potential range of activated carbon. They will repeatedly release lithium ions as the hybrid cell is charged and accept then as the cell is discharged. The Type C lithium ion source materials include: Li₂RuO₃ which is highly reversible.

Specific lithium transition metal oxides such as LiCoO₂, LiNi_{(1-x-y)}CoₓMn_{y}O₂, LiNi_{(1-x-y)}CoₓAl_{y}O₂, and LiFePO₄.

Some of these Type C lithium ion source materials have been used as electrode materials in lithium ion batteries and can be adapted for use with activated carbon particles in capacitor electrodes for the lithiation of graphite anode materials. In general, it is preferred that the particles of a Type C LiSM make up about two to seventy percent by weight of the LiSM+AC content of the active materials of the capacitor electrode.

It is also believed that the subject practice of using LiSM materials for the lithiation of a graphite anode positioned adjacent to a capacitor electrode in a hybrid cell may also be used to enhance the lithiation of other anode materials such as carbonaceous material (e.g., hard carbon, soft carbon, and the like, Li₄Ti₅O₁₂, silicon, tin, tin oxide, transition metal oxides, and the like.

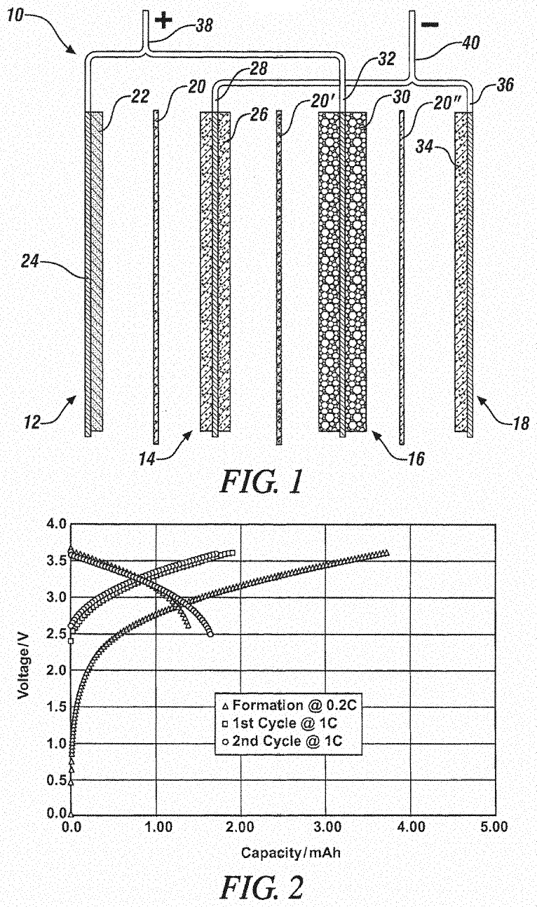

FIG. 1 illustrates the four electrode members of a basic hybrid lithium-ion battery/activated carbon capacitor cell 10 with three separators placed between the four electrodes. FIG. 1 illustrates a side edge view in cross-section of the cell members. In an assembled cell, the four electrodes and inter-placed separators would be like-shaped and sized and stacked against each other. For example, the electrodes and separators are often flat and rectangular (e.g., 50 mm by 55 mm) and less than a millimeter in thickness. But in the hybrid cell 10, illustrated in FIG. 1, the electrodes and separators are spaced-apart and illustrated from one edge side to enable an easier description of the components and structures of the electrodes and their respective positions in the assembled cell.

Viewed from left-to-right in FIG. 1, hybrid cell 10 comprises a lithium iron phosphate cathode 12, a first graphite anode 14, an activated carbon capacitor cathode 16 and a second graphite anode 18. Inserted between the respective electrodes are three like-shaped and formed separators 20, 20′, and 20″. This illustration of hybrid cell 10 is a non-limiting example of a basic hybrid cell. Other examples, may include different electrode configurations and electrode-coating practices, such as one-side or two-sided coatings of electrode materials on a current collector.

The lithium iron phosphate (sometimes LFP herein) cathode 12 is formed of a porous layer of micrometer-size particles of lithium iron phosphate 22, resin-bonded to one side of an aluminum current collector 24. The porous layer of lithium iron phosphate particles 22 may contain a minor portion of electrically conductive carbon particles. As illustrated in FIG. 1, the current collector 24 of the LFP cathode 12 is electrically connected to the current collector 32 of the activated carbon capacitor cathode (AC) 16. AC capacitor cathode 16 is formed of porous layers 30 of activated carbon particles, mixed with particles of a selected lithium ion source material (LiSM), which are resin-bonded to both major surfaces of the aluminum current collector 32. The metal foil electrical connection 38 joining LFP current collector 24 and the AC current collector 32 extends outside the container package (not illustrated) and is positively charged when hybrid cell 10 is being discharged. Thus, porous layers 30 comprise a mixture of small particles of activated carbon and lithium ion source material.

Hybrid cell 10 also comprises a pair of electrically connected graphite anodes 14, 18. A first graphite anode 14 is positioned between LFP cathode 12 and the AC/LiSM capacitor 16. Graphite anode 14 is formed of porous layers 26 of micrometer-size graphite particles (which may contain a small portion of electrically conductive carbon particles) which are resin-bonded to both sides of a thin copper current collector 28. And the second graphite anode 18 comprises a single porous layer of small graphite particles 34 resin-bonded to one side of a thin copper current collector 36. The single porous layer of graphite anode material (in this basic hybrid cell) is placed facing one side of the AC/LiSM capacitor 16.

The metal foil electrical connection 40 between copper current collectors 28, 36 extends outside the container (not illustrated) of the assembled cell and is negatively charged when hybrid cell 10 is being discharged.

When hybrid cell 10 is assembled and subjected to formation cycling, LFP layer 22 would lie against one side of separator 20 and one side of the graphite anode 14 would lie against the other side of separator 20. Similarly, separators 20′ and 20″ lie against surfaces of graphite anodes and

AC/LiSM capacitor as illustrated in FIG. 1. After hybrid cell 10 has been placed in a suitable container, the pores of each electrode 12, 14, 16, 18 and separators 20, 20′, 20″ would be carefully infiltrated with a selected non-aqueous liquid electrolyte which is not illustrated in FIG. 1. Electrical connectors 38, 40 for cell 10 would extend outside of the closed container enclosing the hybrid cell 10 and any additional cells to be combined with it.

It is to be understood that hybrid cell 10, illustrated in FIG. 1, is a basic cell unit. In many assembled battery/capacitor electrochemical cells, this basic hybrid cell unit 10 may be repeated as a hybrid cell unit and combined with additional battery cell units in order to achieve a desired combination of battery properties and capacitor properties.

In the above example, particles of lithium iron phosphate (LiFePO₄) were used as the active material for the cathode. Other non-limiting examples of suitable cathode materials for the hybrid cell include particles of lithium manganese oxide (LiMn₂O₄), particles of a lithium manganese cobalt oxide (LiNi_{(l-x-y)}CoₓMn_{y}O₂), and/or particles of a lithium nickel cobalt aluminum oxide (LiNi_{(l-x-y)}CoₓAl_{y}O₂). As stated, the particles of electrode material may be mixed with small particles of electrical-conductivity enhancing carbon particles or the like.

In a hybrid cell, the particles of active electrode material typically have a largest dimension in the range of about 0.5 to 30 micrometers and they are bonded as a porous electrode layer to one or both sides of a suitable metallic current collector foil (typically aluminum or copper) having a thickness in the range of about 4 to 25 micrometers and a two-dimensional coated-area shape of the intended electrode. The current collector foil typically has an uncoated tab, or the like, of a size and shape for electrical connection of its electrode to other electrodes in the assembled cell.

In general, the activated carbon capacitor particles, the graphite anode particles, or the selected lithium-ion cell cathode particles are coated or otherwise suitably mixed with a suitable amount of bonding material for formation of the porous electrode layer on one or both surfaces of a current collector foil. For example, the particles may be dispersed or slurried with a solution of a suitable resin, such as polyvinylidene difluoride dissolved in N-methyl-2-pyrrolidone and spread and applied to a surface of current collector in a porous layer. Other suitable binder resins include carboxymethyl cellulose/styrene butadiene rubber resins (CMC/SBR) or polytetrafluoroethylene (PTFE). The binders are typically not electrically conductive and should be used in a minimal amount to obtain a durable coating layer of porous electrode material on the current collector surface without fully covering the surfaces of the particles of electrode material.

In many battery constructions, the separator material is a porous layer of a polyolefin, such as polyethylene (PE), polypropylene (PP), non-woven, cellulose/acryl fibers, cellulose/polyester fibers, or glass fibers. Often the thermoplastic material comprises inter-bonded, randomly oriented fibers of PE or PP. The fiber surfaces of the separator may be coated with particles of alumina, or other insulator material, to enhance the electrical resistance of the separator, while retaining the porosity of the separator layer for infiltration with liquid electrolyte and transport of lithium ions between the cell electrodes. The separator layer is used to prevent direct electrical contact between the facing negative and positive electrode material layers and is shaped and sized to serve this function. In the assembly of the cell, the facing major faces of the electrode material layers are pressed against the major area faces of the separator membrane. A liquid electrolyte is infiltrated or injected into the pores of the separator and electrode material particulate layers.

The electrolyte for a subject hybrid lithium-ion battery/capacitor cell may be a lithium salt dissolved in one or more organic liquid solvents. Examples of suitable salts include lithium hexafluorophosphate (LiPF₆), lithium tetrafluoroborate (LiBF₄), lithium perchlorate (LiCl₄), lithium hexafluoroarsenate (LiAsF₆), and lithium trifluoroethanesulfonimide. Some examples of solvents that may be used to dissolve the electrolyte salt include ethylene carbonate (EC), dimethyl carbonate (DMC), methylethyl carbonate (EMC), and propylene carbonate (PC). There are other lithium salts that may be used and other solvents. But a combination of lithium salt and solvent is selected for providing suitable mobility and transport of lithium ions in the operation of the hybrid cell with its battery and capacitor electrode combinations. The electrolyte is carefully dispersed into and between closely spaced layers of the electrode elements and separator layers.

In addition to the electrolyte salt(s) and non-aqueous solvent(s), suitably small portions of other additives may be included in the electrolyte solution. For example, it may be desired to add one or more of vinylene carbonate (VC), fluoroethylene carbonate (FEC), or lithium bis(oxolato) borate (LiBOB) to enhance the formation of the solid electrolyte interface on the graphite particles of the anode. It may be desired to add N, N-diethylamino trimethyl silane as a cathode protection agent. Tris (2,2,2-trifluoroethyl) phosphate may be added as stabilizer for LiPF₆ electrolyte salt. Further, a suitable additive as a safety protection agent and/or as a lithium deposition improver may be added.

In the four-electrode hybrid cell unit of this disclosure (as illustrated in FIG. 1) two graphite anodes 14, 18 are positioned on opposite sides of an activated carbon AC capacitor cathode 16. A LFP cathode 12 (or other suitable cathode composition) is located on the other side of one of the graphite anodes 14. In FIG. 1, the graphite anode 14, located between LFP cathode 12 and AC capacitor 16, is formed with its current collector foil 28 coated on both major surfaces with a porous layer of graphite particles 26. One of its layers of graphite particles 26 faces the LFP cathode and the other layer faces one coated side of the activated carbon capacitor. In this example, the current collector foil 36 of graphite anode 18 is coated on one side (in this cell unit) with a porous layer of graphite particles 34.

A basis and purpose of the subject invention and disclosure of the addition of particles of lithium ion source material to the activated carbon capacitor particles 30 of capacitor cathode 16 is to provide a source of lithium ions with the particles of activated capacitor material 30 in capacitor cathode 16. Otherwise, the only sources of lithium are in the electrolyte in the lithium-ion capacitor electrode side. The following experiment demonstrates a previously unrecognized problem. The experiment uses only an activated carbon electrode and a LiPF₆ electrolyte in trying to perform cycles on a graphite electrode. For example, in FIG. 1, the graphite anode 18 and the graphite anode 14 face only the activated carbon capacitor cathode.

A pure lithium capacitor cell (LIC) was formed using a one-side coated graphite anode layer (−) electrode and an opposing one-side coated capacitor (+) electrode. The electrolyte was 1.2 M LiPF₆ dissolved in EC:DMC:EMC=1:1:2. The newly formed cell was operated with a formation cycle at 0.2C and two charge-discharge cycles to determine the available capacity of the LIC cell in which the only source of lithium ions was the electrolyte.

The Voltage vs. Capacity results are presented in FIG. 2. During the formation cycle the applied voltage was increased to about 3.6 volts. The transfer of lithium ions from the electrolyte into the graphite anode led to an initial charge capacity of about 3.7 mAh. During the initial charge process, the AC cathode absorbs the PF₆ anions, while the lithium cations are transported to the graphite anode, which is followed by SEI formation and Li+ intercalation on the graphite anode. This process corresponds to the capacity of 3.7 mAh, which is limited by the AC's capacity.

During the subsequent two charge-discharge cycles, the retained capacity is well less than 2 mAh.

It was apparent that during charging of the graphite anode, the active carbon cathode and the electrolyte could only enable a limited quantity of lithium ions to be transported to and into the graphite particles. However, during such a charging process, lithium ions, engage the graphite particles, and a solid electrolyte interface (SEI) on the surfaces of the graphite particles is formed. A substantial portion of the lithium content of the electrolyte becomes irreversibly retained in the surface coatings on the particles of the graphite anode. Accordingly, as stated repeatedly above in the text of this specification, the purpose and goal of this invention is to provide a source of lithium ions with the activated carbon particles of the capacitor electrode to provide a reliable source of lithium ions (in addition to the lithium ions in the electrolyte) for use in the formation and activation of graphite anode material layers immediately adjacent to the graphite anode surfaces.

This invention has been illustrated with some examples which are not intended to be limiting of the scope of the invention.

1. A hybrid lithium-ion battery/capacitor electrochemical cell comprising (i) a group of two electrically-connected anodes formed of porous layers of graphite particles, (ii) a cathode formed of a porous layer of particles of a lithium compound electrically-connected to a capacitor electrode formed of a porous layer of particles of activated carbon, the capacitor electrode being placed between the anodes with the cathode facing one of the anodes, (iii) porous separators physically separating the electrodes in a closely-spaced assembly, and (iv) a non-aqueous liquid electrolyte, conductive of lithium cations and compatible anions, infiltrating the porous layers of each of the electrodes and the inter-placed separators to permit the transport of lithium cations and the compatible anions to and from each of the electrode particle layers as the electrochemical cell is being charged and discharged;
the capacitor further comprising particles of a lithium compound, mixed with the activated carbon particles, the composition and quantity of the particles of the lithium compound being selected to contribute lithium ions to the electrolyte during formation cycling of the hybrid cell when the graphite particles in the anodes are initially being lithiated to form a solid electrolyte interface on surfaces of the graphite particles.

2. A hybrid lithium-ion battery/capacitor electrochemical cell as stated in claim 1 in which the weight of the particles of the lithium compound initially mixed with the activated carbon particles is in the range of two percent to seventy percent of the combined weights of the activated carbon particles and the particles of the lithium compound.

3. A hybrid lithium-ion battery/capacitor electrochemical cell as stated in claim 1 in which the particles of the lithium compound mixed with the activated carbon particles of the capacitor electrode are one of a lithium compound selected from 3,4-dihydroxybenzonitrile dilithium, lithium salts including azides (LiN₃), oxocarbons, dicarboxylates, and hydrazides, lithium nitride (Li₃N), lithium nickel oxide (e.g., Li_{0.65}N_{1.35}O₂, Li₅FeO₄, Li₅ReO₆, Li₆CoO₄, Li₃V₂(PO₄)₃, and other lithium transition metal oxides.

4. A hybrid lithium-ion battery/capacitor electrochemical cell as stated in claim 3 in which the weight of the particles of the lithium compound mixed with the activated carbon particles of the capacitor electrode is in the range of two to thirty percent of the combined weights of the activated carbon particles and the particles of the lithium compound.

5. A hybrid lithium-ion battery/capacitor electrochemical cell as stated in claim 1 in which the particles of the lithium compound mixed with the activated carbon particles of the capacitor electrode are one of lithium fluoride and LiF/transition metal composites such as Li₂O/Co, Li₂O/Fe, and Li₂O/Ni, Li₂S, and Li₂S metal composites such as Li₂S/Co, lithium cuprate (Li₂CuO₂), Li₂NiO₂, Al₂O₃-coated Li₂NiO₂ and other oxides coated with Li₂NiO₂ and Li₂MoO₃.

6. A hybrid lithium-ion battery/capacitor electrochemical cell as stated in claim 5 in which the weight of the particles of the lithium compound mixed with the activated carbon particles of the capacitor electrode is in the range of two to thirty percent of the combined weights of the activated carbon particles and the particles of the lithium compound.

7. A hybrid lithium-ion battery/capacitor electrochemical cell as stated in claim 1 in which the particles of the lithium compound mixed with the activated carbon particles of the capacitor electrode are one of Li₂RuO₃, LiCoO₂, LiNi_{(l-x-y)}CoₓMn_{y}O₂, LiNi_{(l-x-y)}CoₓAl_{y}O₂, and LiFePO₄.

8. A hybrid lithium-ion battery/capacitor electrochemical cell as stated in claim 7 in which the weight of the particles of the lithium compound mixed with the activated carbon particles of the capacitor electrode is in the range of two to seventy percent of the combined weights of the activated carbon particles and the particles of the lithium compound.

9. A hybrid lithium-ion battery/capacitor electrochemical cell as stated in claim 1 in which the electrolyte is a non-aqueous solution of LiPF₆.

10. A hybrid lithium-ion battery/capacitor electrochemical cell comprising (i) a group of two electrically-connected anodes formed of porous layers of graphite particles, (ii) a cathode formed of a porous layer of particles of lithium iron phosphate electrically-connected to a capacitor electrode formed of a porous layer of particles of activated carbon, the capacitor electrode being placed between the anodes with the cathode facing one of the anodes, (iii) porous separators physically separating the electrodes in a closely-spaced assembly, and (iv) a non-aqueous liquid electrolyte, conductive of lithium cations and compatible anions, infiltrating the porous layers of each of the electrodes and the inter-placed separators to permit the transport of lithium cations and the compatible anions to and from each of the electrode particle layers as the electrochemical cell is being charged and discharged;
the capacitor electrode further comprising particles of a lithium compound, mixed with the activated carbon particles, the composition and quantity of the particles of the lithium compound being selected to contribute lithium ions to the electrolyte during formation cycling of the hybrid cell when the graphite particles in the anodes are initially being lithiated to form a solid electrolyte interface on surfaces of the graphite particles.

11. A hybrid lithium-ion battery/capacitor electrochemical cell as stated in claim 10 in which the particles of the lithium compound mixed with the activated carbon particles of the capacitor electrode are one of Li₂RuO₃, LiCoO₂, LiNi_{(l-x-y)}CoₓMn_{y}O₂, LiNi_{(l-x-y)}CoₓAl_{y}O₂, and LiFePO₄.

12. A hybrid lithium-ion battery/capacitor electrochemical cell as stated in claim 11 in which the weight of the particles of the lithium compound mixed with the activated carbon particles of the capacitor electrode is in the range of two to seventy percent of the combined weights of the activated carbon particles and the particles of the lithium compound.
